(19) United States
(12) Patent Application Publication
(10) Pub. No.: US 2010/0189935 A1
(43) Pub. Date: Jul. 29, 2010

(54) FILM FOR ELECTRIC HOME APPLIANCE AND HOME APPLIANCE USING THE SAME

(75) Inventor: Kyung-Do Kim, Changwon City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/709,232

(22) Filed: Feb. 19, 2010

Related U.S. Application Data
(63) Continuation of application No. PCT/KR2008/004678, filed on Aug. 12, 2008.

(30) Foreign Application Priority Data
Aug. 20, 2007 (KR) 10-2007-0083639

(51) Int. Cl. B32B 1/02; B32B 15/08; B32B 5/00; B32B 27/38; B32B 17/04; B32B 17/00

(52) U.S. Cl. 428/34.5; 428/457; 428/458; 428/336; 428/414; 428/339; 428/335; 428/35.9; 428/34.7

(57) ABSTRACT

The present invention relates to an external film for an electric home appliance and a home appliance using the same, there are advantages in that strength of the external film is reinforced and the product is reduced in weight while having the feeling of texture of metal materials, as a PET layer or a PVC layer is provided at upper and lower surfaces of a metal layer such as an A1 layer.

### TECHNICAL FIELD

This document relates to a film for an electric home appliance and a home appliance using the same.

### BACKGROUND ART

Generally, the appearance of electric home appliances, such as refrigerators, air-conditioners, washing machines and ovens, is formed of plastic or metal material. Recently, these electric home appliances are configured to have various colors, patterns or textures in accordance with user's requirements and trends.

In particular, electric home appliances, which have outstanding appearance by use of metal materials such as aluminium, are preferred by consumers, and the overall appearance or some part of the electric home appliances is formed by the metal materials.

These metal materials are provided at some external parts, in particular at circumferential surfaces or edges, of the electric home appliances, or they are generally applied to decorative elements which emphasize specific parts visually or a handle to which a hand of the user is directly contacted.

This may enhance the durability of the handle, for example this prevents the handle to which load is repeatedly applied from being broken, as well as allow the user to recognize inherent texture of metals.

However, these metal materials are relatively expensive, use of such an expensive material will cause an increase in the production cost, and use of such a heavy material will cause an increase in the product weight, thereby reducing mobility.

Also, in case the handle is made of metal materials, leakage current may be transferred to the door during the use of electric home appliance, and therefore this causes an accident due to the leakage current when operated by the user, or this cause emotional dissatisfaction of the user.

In addition, it is difficult for metal materials to exhibit various colors or textures because surface treatment of the metal materials is limited, in particular in case of surface treating aluminium material by anodizing, yellow color series are shown, and therefore it is somewhat difficult to provide accurate color renditions.

### DISCLOSURE OF INVENTION

### Technical Problem

An object of the present invention is to solve the above problems and to provide an external film for an electric home appliance and a home appliance having the same attached thereto, which allows a surface of the electric home appliance to have texture of metals while reducing total weight of the products.

### Technical Solution

To achieve the foregoing objects, and in accordance with the purpose of the invention as embodied and broadly described therein, there is provided an external film for an electric home appliance including: a metal layer attached to an attached part; and a plastic film layer provided at upper and lower surfaces of the metal layer to reinforce strength of the metal layer and/or to improve surface properties thereof, wherein the plastic film layer includes a first film layer provided at the upper surface of the metal layer and a second film layer provided at the lower surface of the metal layer.

in another aspect of the present invention, there is provided an electric home appliance including: a body in which a space of a predetermined size is formed; a front part where it is fixed to the body or at least some of it is detachably coupled to the body; an external part which constitutes some of the front part or is coupled to the front part; and an external film which is attached to the external part to create metalic texture, wherein the external film includes a metal layer, a plastic layer which is respectively provided at upper and lower surfaces of the metal layer, and a coating layer which is disposed on a surface of the plastic layer provided at the upper surface of the metal layer.

### Advantageous Effects

In an external film for an electric home appliance according to the embodiment of the present invention, some or the whole of the external appearance of the electric home appliance has a feeling similar to the real metal, even though real aluminium is not used. And, the reduction in manufacturing costs will reduce the overall weight of the product.

Also, irregularities or defects of surfaces of the electric home appliance can be covered by forming a PET layer or a PVC layer at a lower surface of an aluminium layer constituting the external film, and therefore there is an advantage in that the aluminium layer has a smooth surface. Further, excellent surface texture may be implemented, as well as the possibility of damage may be considerably reduced by reinforcing the strength of the external film.

Also, since additional processings such as various colors or patterns can be implemented by forming a PET layer on an upper surface of the aluminium layer, and therefore it is possible to exhibit various textures even though a relatively thin aluminium layer is used.

And, the reduction in the whole manufacturing cost and the reduction in weight can be further increased by attaching the external film to the external part of FRP material.

### BRIEF DESCRIPTION OF THE DRAWINGS

FIG. 1 is a perspective view showing an external appearance of a refrigerator having an external film for electric home appliances according to a preferred embodiment of the present invention.

FIG. 2 is a partial perspective view showing an external appearance of a handle of a refrigerator having an external film for electric home appliances according to a preferred embodiment of the present invention.

FIG. 3 is a cross-sectional view of an external film for electric home appliances according to a preferred embodiment of the present invention, taken along I-I′ in FIG. 1.

FIG. 4 is a cross-sectional view of an external film for electric home appliances according to another preferred embodiment of the present invention, taken along I-I′ in FIG. 1.

FIG. 5 is an external perspective view of an oven having an external film for electric home appliances according to a preferred embodiment of the present invention.

FIG. 6 is a front view of an air-conditioner having an external film according to a preferred embodiment of the present invention.

### MODE FOR THE INVENTION

Hereinafter, preferred embodiments of the present invention will be explained in detail with reference to the accompanying drawings. However, it will be recognized that neither the illustration of examples of a film within the scope of the present invention nor the description thereof are by way of limitation and that other embodiments also within the scope of the present invention will occur to those skilled in the art upon reading the disclosure set forth hereinafter.

An external film for electric home appliances may be applied to a refrigerator, an air-conditioner, a washing machine, an oven and so on.

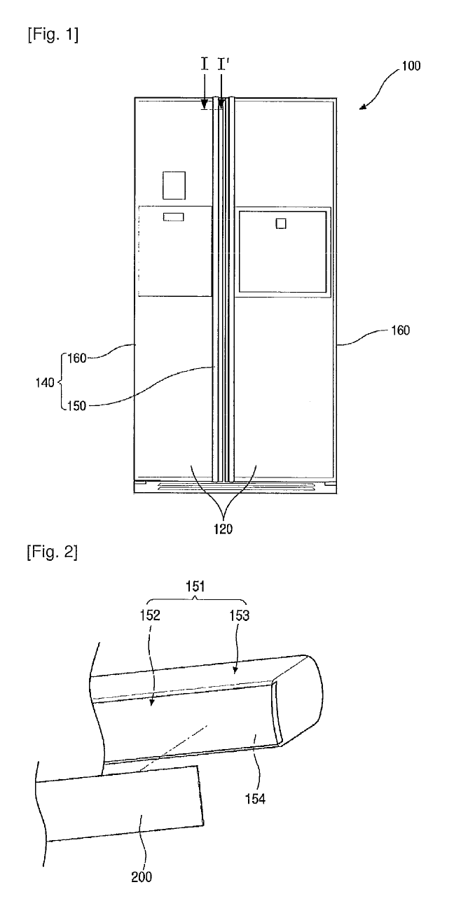

FIG. 1 shows an external appearance of a refrigerator to which an external film for electric home appliances according to a preferred embodiment of the present invention is applied, in a perspective view.

Referring to FIG. 1, the external appearance of the refrigerator 100 is formed approximately in the shape of a rectangular trapezium, and a body constituting a storage space is formed to be divided into a refrigerating chamber and a freezing chamber.

FIG. 1 shows, for example, a side by side type refrigerator in which a refrigerating chamber and a freezing chamber are horizontally arranged side-by-side, however it may be applied to a top mount type refrigerator in which a freezing chamber is disposed at an upper portion and to a bottom freezer type refrigerator in which a freezing chamber is disposed at a lower portion.

Specifically, a front surface of the body, that is a front surface of the refrigerating and freezing chambers is formed to be open, the opened front surfaces of the refrigerating and freezing chambers are configured to be selectively closed by a door 120, which is respectively and pivotably installed.

The external appearances of the body of the refrigerator 100 and/or the door 120 are formed by a color coated steel sheet or a tempered glass, and they may be formed to have various colors and patterns. And, an external part 140 including a deco element 160, a handle 150 and so on may be provided at the body and/or the door 120.

The deco element 160, which functions to improve the appearance of the refrigerator 100, may be installed at an edge of the body of the refrigerator 100 and/or at a periphery of the door 120. And, the deco element 160 may include a parent material of fiber glass reinforced plastic (FRP), and an external film which is attached to some or all of an outer circumferential surface and has a metallic texture. The parent material and external film will be explained in detail below.

FIG. 2 shows an external appearance of a handle of a refrigerator to which an external film for electric home appliances according to a preferred embodiment of the present invention is applied, in a partial perspective view.

Referring to FIG. 2, the handle 150 includes a parent material 151 includes a parent material 151 forming an external shape, and an external film 200 showing a texture.

The parent material 151 is made of fiber glass reinforced plastic (FRP) and forms an external shape of the handle 150, and it may include a first parent material 152 and a second parent material 153. The first parent material 152 may be applied to a portion where a relatively low strength is required, and it forms a front surface of the handle 150. According to the needs, a separate ornament such as a cubic is attached to the first parent material 152.

Specifically, the fiber glass reinforced plastic constituting the first parent material 152 includes a glass fiber of 20˜40 wt % and a resin of 60˜80 wt %. Here, weight ratio of the glass fiber affects the strength of the fiber glass reinforced plastic, and in case the weight ratio of the glass fiber is 20 wt % or less, thermal deformation is generated in the atmosphere of using electric home appliances (a temperature range of about −30° C. ˜60° C.) or damage may be occurred by repeated application.

Meanwhile, the glass fiber may be cut into a length of about 3 mm, and the first parent material 152 is formed by mixing it with thermoplastic resins such as acrylonitrile butadiene styrene copolymer (ABS), styrene acrylonitrile copolymers (SAN) and nylon. The first parent material 152 may be extruded to a depth of about 1.2 mm or more.

In case the external film 200 according to the embodiment of the present invention is attached to the first material 152, resin is re-applied by a co-extrusion to a front surface of the the first material 152 where the external film 200 is attached, thereby forming an attaching surface 154. The attaching surface 154 has uniform illuminance of the first parent material 152 and promotes the attachment of the external film 200 and further improves the appearance, since the resin is re-applied thereto.

Meanwhile, the second parent material 153 forms a portion where a relatively high strength is required, and it forms both side surfaces and a bottom surface of the handle 150.

The FRP forming the second parent material 153 includes a fiber glass of 50˜70 wt % and a resin of 30˜50 wt %. Here, weight ratio of the glass fiber affects the strength of the fiber glass reinforced plastic, and in case the weight ratio of the glass fiber is 50 wt % or less, damage may be occurred by repeated application because the strength is below the required strength.

The glass fiber constituting the second parent material 153 has fiber tissues arranged in one direction, and it may be configured as a net type such as textile fabrics, and t may be configured by at least one layer. In case the glass fiber of the second parent material 153 is stacked in multiple layers, the effects of deformation and shrinkage are reduced.

Also, the glass fiber is mixed with thermosetting resins such as polyester to form the second parent material 153, and it may be drawn to a depth of about 1.5 mm or more.

The external shape of the handle 150 is formed by the connection of the first parent material 152 and the second parent material 153. However, in case the weight load applied to the handle 150 is light because the length of the handle 150 is relatively short (less than 60 cm), the whole external shape of the handle 150 can be made of fiber glass reinforced plastic having the same composition as the first parent material 152. On the other hand, in case the weight load applied to the handle 150 is heavy because the length of the handle 150 is relatively short (more than 60 cm), the whole external shape of the handle 150 can be made of fiber glass reinforced plastic having the same composition as the second parent material 153.

Also, the deco element 160 may be formed of fiber glass reinforced plastic having the same composition as the first and second parent materials 152, 153, although the external shape of the deco element is different from the handle 150. That is, the deco element 160 may be formed of fiber glass reinforced plastic having the same composition as the second parent material 153, and a portion where a relatively low weight load is applied may be formed of fiber glass reinforced plastic having the same composition as the first parent material 152.

Meanwhile, an external film 200 is further attached to the whole or some of an outer surface of the handle 150 and the deco element 160 in order to exhibit metallic texture.

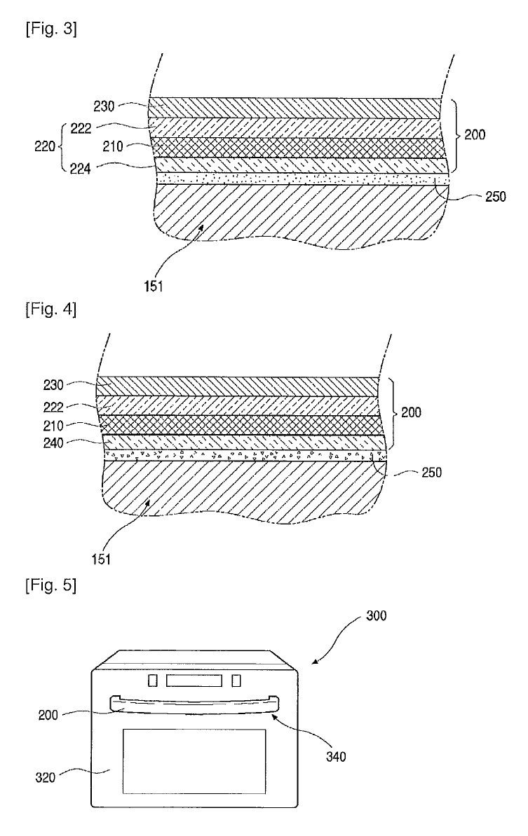

FIG. 3 is a cross-sectional view of an external film for electric home appliances according to a preferred embodiment of the present invention, and it is a cross-sectional view taken along in FIG. 1.

Referring to FIG. 3, the external film 200 is attached to a surface of the parent material 151 so that the external parts 140, i.e. the deco element 160 and the handle 150 have a texture of metal materials such as aluminium. Specifically, the external film 200 includes an aluminium layer 210, a PET layer 220 and a coating layer 230. Here, the PET layer 220 is provided at upper and lower surfaces of the aluminium layer 210, and it is respectively configured as an upper surface PET layer 222 and a lower surface PET layer 224. Although an aluminium layer 210 is used as a material forming the external film 200, however the present invention is not restricted thereto, and it is apparent those skilled in the art that various kinds of metal layers can be applied.

More specifically, a lower surface PET layer 224 is formed at the lowermost of the external film 200, i.e. at the lower surface of the aluminium layer 210. The lower surface PET layer 224 is to cover an uneven surface of the parent material 151 as well as to reinforce the strength of the external film 200, and it may be formed of a polyethylen therephthalate (PET) material to have a thickness of 10˜50 μm.

In a state where a surface of the parent material 151 is not smooth as defects are formed or it is damaged during the processing of the parent material 151 which is an attached part to be attached to the lower surface PET layer 224, there is a possibility of forming irregularities on the surface of the aluminium layer 210 when attaching the external film 200. However, since the surface defects of the parent material 151 is covered as the surface of the parent material is completely covered by the lower surface PET layer 224, and the aluminium layer 210 may have a smooth surface as surface defects of the parent material 151 is covered.

The lower surface PET layer 224 serves to reinforce the strength of the external film 200 as well as to cover the surface defects thereof, since the strength of it is greater than the conventional film elements.

Meanwhile, the aluminium layer 210 functions to allow the external film 200 to exhibit metallic texture, it may be formed as an aluminium thin plate of 20˜200 μm depth. And, an upper surface PET layer 222 is formed at an upper surface of the aluminium layer 210. The upper surface PET layer 222 serves to protect a surface of the aluminium layer 210 as well as to improve the texture, it may be formed of a PET material to have a thickness of approximate 10˜50 μm.

Also, a hair line and/or an embossing pattern may be formed at the upper surface PET layer 222 so that the external film 200 can have more improved texture of metal materials. According to the needs, feelings of color or texture of the external film 200 may be implemented in various ways as it is toned to various colors or is plated.

In particular, the upper surface PET layer 222 may implement various colors as well as have more vivid feeling of texture of metal materials, which the conventional real aluminium could not have.

Further, a coating layer 230 is formed at an upper surface of the upper surface PET layer 222, i.e. at the uppermost surface of the external film 200. The coating layer 230 aims to increase the scratch resistance and hardness of the external film 200 and is formed by a general UV coating or a thermal curable coating, and it may be formed to a thickness of 5˜15 μm.

Meanwhile, two-part adhesive 250 is applied between the external film 200 and parent material 151 so that the external film 200 and parent material 151 are completely adhered to each other without being separated. That is, the two-part adhesive 250 in which polyurethanes and epoxies are mixed is applied between a surface of the parent material 151 and a lower surface of the lower surface PET layer 224, so that the lower surface PET layer 224 is stably attached to the parent material 151 which is an attached part.

This two-part adhesive 250 is to allow the lower surface PET layer 224 having poor adhesive properties to be adhered to the parent material 151 which is an attached part, it may also be applied to the adhesion of a PVC layer 240 and the parent material 151.

As the external film 200 is fully attached to the parent material 151, the external part 140 may have the same strength as aluminium as weft as the same feeling of texture as aluminium.

FIG. 4 is a cross-sectional view of an external film for electric home appliances according to another preferred embodiment of the present invention, where it is a cross-sectional view taken along I-I′ in FIG. 1.

Referring to FIG. 4, instead of the lower surface PET layer 224, a PVC layer 240 having similar physical properties may also be provided. Since the PVC layer 240 also have the same function as the lower surface PET layer 224, the another embodiment of the external film 200 shown in FIG. 4 is almost same as the above embodiment of FIG. 3 except for the PVC layer 240, a further detailed description thereof will be omitted.

Table 1, shown below, displays an experiment in which various adhesives are used to attach the external film to the parent material which is an attached part, this will be described below.

TABLE 1

| | Type | | | |
|---|---|---|---|---|
| Base film | Test | Solvent | Hot-melt | 2 liquid Reaction |
| PVC | Finger mark | X | Δ | X |
| | Adhesive strength | Δ | X | |
| AI | Finger mark | X | ▴ | ▴ |
| | Adhesive strength | Δ | ▴ | ▴ |
| PET | Finger mark | X | ▴ | |
| | Adhesive strength | Δ | Δ | |

According to Table 1, it is noted that adhesive strength of the lower surface PET layer 224 is not strong enough as well as is a little bit vulnerable to finger marks, when it is adhered by solvent or by thermal bonding. However, it is represented that the adhesive strength and finger mark resistance are considerably improved, when the two-part adhesive 250 in which polyurethanes and epoxies are mixed is used.

And, as in the embodiment of FIG. 4, it is represented that the adhesive strength and finger mark resistance are not excellent when the adhesion is made by solvent or by thermal bonding although a PVC layer 240 of a PVC material is formed instead of the lower surface PET layer 224, however the adhesive strength is excellent when using the two-part adhesive 250.

Meanwhile, referring to the result of the experiments in which solvent, thermal bonding and the two-part adhesive 250 are used to attach the aluminium layer 210 to the parent material 151 directly, the adhesive strength is not excellent as well as the finger mark resistance is rarely excellent in either case.

That is, in a state where the lower surface PET layer 224 or the PVC layer 240 is interposed below the aluminium layer 210, the adhesion by using the two-part adhesive 250 is advantageous to the improvement in adhesive strength. And, when the finger mark resistance is required, it is preferable to provide the lower surface PET layer 224 rather than the PVC layer 240 at the lower surface of the external film 200.

As described above, in case of attaching the external film 200 to the external part 140 of electric home appliances, the external part 140 is reduced in weight compared to that of using real aluminium. The weight reduction of this external part 140 is further accomplished by forming the external part 140 from FRP material, together with the use of the external film 200.

Specifically, since the FRP has a specific strength greater than A1, it is possible to make the external part 140 more lightweight while maintaining the same strength. Therefore, the handle 150 formed of FRP can be made light, compared to the handle 150 made of aluminium having the same strength. And, the feeling of texture of aluminium may be implemented by the attachment of the external film 200.

FIG. 5 shows an oven having an external film for electric home appliances according to a preferred embodiment of the present invention in an external perspective view.

Referring to FIG. 5, an external appearance of the oven 300 is formed by a body having an approximate rectangular parallelepiped shape, and a door 320 for selectively closing an opened front surface of the body.

The external appearance of the body and door 320 of the oven 300 is formed of metal or plastic materials, and a handle 340 is formed at one side of the door 320. The handle 340 may be formed the same way as the handle 150 for the refrigerator of the above-described embodiment. That is, the external appearance of the handle 340 may be formed of FRP, and an external film 200 having the feeling of metallic texture such as aluminium may be further attached to a surface exposed to the outside. Of course, the external film 200 is configured in the same way as the external film 200 according to the above-described embodiment.

Therefore, the handle 340 is lighter than that made of aluminium, while having the similar strength and the feeling of texture. Further, the deformation and the transmission of residual current caused by temperature may be prevented.

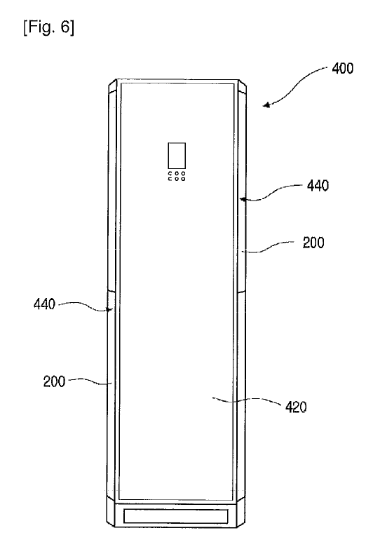

FIG. 6 shows an air-conditioner having an external film according to a preferred embodiment of the present invention in a front view.

Referring to FIG. 6, an indoor unit 400 of an air-conditioner may be configured to have a polygon shape in cross-section, a plurality of parts such as an evaporator and a fan constituting the refrigerating cycle are provided therein.

Also, a front pate 420 is attached to a front surface of the indoor unit 200. The front plate 420, which forms a front external appearance of the indoor unit 400, may be formed of a color coated steel sheet or a tempered glass. And, various colors and patterns may be implemented on the front plate 420.

Also, a deco element 440 may be installed at an outer periphery of the front plate 420 and/or at both side surfaces of a case forming the external shape of the air-conditioner indoor unit 400. The deco element 440 may be formed of fiber glass reinforced plastic (FRP) in the same way as the deco element 160 for the refrigerator according to the above-described embodiment. And, an external film 200, as described in the above embodiment, may be attached to the front surface of the deco element 400. Therefore, the indoor unit 400 can be also reduced in weight while having excellent texture and strength, as well as manufacturing costs can be considerably decreased.

1. An external film for an electric home appliance comprising:
a metal layer attached to an attached part; and
a plastic film layer provided at upper and lower surfaces of the metal layer to reinforce strength of the metal layer and/or to improve surface properties thereof, wherein the plastic film layer includes a first film layer provided at the upper surface of the metal layer and a second film layer provided at the lower surface of the metal layer.

2. The external film for the electric home appliance according to claim 1, wherein the first film layer includes a film layer made of PET material where tuning and patterning processings are possible.

3. The external film for the electric home appliance according to claim 1, wherein the second film layer includes a film layer made of PET material which covers a surface of the attached part.

4. (canceled)

5. The external film for the electric home appliance according to claim 1, wherein an UV coating layer for improving hardness is formed at an upper surface of the first film layer.

6. The external film for the electric home appliance according to claim 5, wherein a thickness of the UV coating layer is 5˜15 μm.

7. The external film for the electric home appliance according to claim 1, wherein a two-part adhesive in which at least polyurethanes and epoxies are mixed is interposed between the second film layer and the attached part.

8. The external film for the electric home appliance according to claim 1, wherein a thickness of the aluminium layer is 20˜200 μm.

9. The external film for the electric home appliance according to claim 1, wherein a thickness of the first and/or second film layers is 10˜50 μm.

10. The external film for the electric home appliance according to claim 1, wherein the metal layer is of aluminium material.

11. An electric home appliance comprising:
a body in which a space of a predetermined size is formed;
a front part where it is fixed to the body or at least some of it is detachably coupled to the body;
an external part which constitutes some of the front part or is coupled to the front part; and
an external film which is attached to the external part to create metallic texture, wherein the external film includes a metal layer, a plastic layer which is respectively provided at upper and lower surfaces of the metal layer, and a coating layer which is disposed on a surface of the plastic layer provided at the upper surface of the metal layer.

12. The electric home appliance according to claim 11, wherein the metal layer includes an aluminium layer.

13. The electric home appliance according to claim 11, wherein the plastic layer includes a PET layer.

14. The electric home appliance according to claim 11, wherein the plastic layer provided at the lower surface of the metal layer is PET layer.

15. The electric home appliance according to claim 11, wherein the external film is attached to the front part by a two-part adhesive in which at least polyurethanes and epoxies are mixed.

16. The electric home appliance according to claim 11, wherein the external part includes a deco element forming a periphery of the front part.

17. The electric home appliance according to claim 11, wherein the external part includes a handle attached to the front part.

18. The electric home appliance according to claim 11, wherein the external part is of fiber glass reinforced plastic (FRP).

19. The electric home appliance according to claim 11, wherein the front part is of tempered glass.

20. The electric home appliance according to claim 11, wherein a hair line and/or an embossing pattern, which is/are to exhibit metallic texture, is/are formed on the plastic layer provided at the upper surface of the metal layer.
